(19) United States
(12) Patent Application Publication
(10) Pub. No.: US 2023/0361350 A1
(43) Pub. Date: Nov. 9, 2023

(54) Artificial Solid Electrolyte Interphase For Enabling Ethylene Carbonate-Free Electrolytes In Lithium-Ion Batteries

(71) Applicant: The Regents of The University of Michigan, Ann Arbor, MI (US)

(72) Inventors: Neil P. Dasgupta, Ann Arbor, MI (US); Yuxin Chen, Ann Arbor, MI (US); Kuan-Hung Chen, Ann Arbor, MI (US); Eric Kazyak, Ann Arbor, MI (US)

(21) Appl. No.: 18/143,358

(22) Filed: May 4, 2023

Related U.S. Application Data
(60) Provisional application No. 63/338,157, filed on May 4, 2022.

(51) Int. Cl. H01M 10/0568; H01M 10/0525; H01M 4/583; H01M 10/0569; H01M 4/04

(52) U.S. Cl. CPC H01M 10/0568; H01M 10/0525; H01M 4/583; H01M 10/0569; H01M 4/0435; H01M 4/0402; H01M 2300/0028

(57) ABSTRACT

A method for forming an electrochemical device may comprise the steps of: (a) exposing electrode material particles to a lithium-containing precursor followed by an oxygen-containing precursor to form a coating on the electrode material particles; (b) forming a slurry comprising the coated electrode material particles; (c) casting the slurry to form a layer; (d) calendering the layer to form one or more electrodes (anode and/or cathode); (e) positioning a separator between the anode and the cathode to form a cell structure; and (f) positioning the cell structure in a liquid electrolyte, wherein the electrolyte is essentially free of a solvent that forms a solid electrolyte interphase on the anode and/or cathode. The method reduces the need for slow, costly preconditioning to be performed following lithium-ion battery cell assembly, and enables the use of ethylene carbonate-free electrolytes, thereby improving cycling stability at high voltages for lithium-ion batteries.

### CROSS-REFERENCES TO RELATED APPLICATIONS

This application claims priority to U.S. Patent Application No. 63/338,157 filed May 4, 2022.

### STATEMENT REGARDING FEDERALLY SPONSORED RESEARCH

This invention was made with government support under grant number DE-AR0000653 awarded by the U.S. Department of Energy. The government has certain rights in this invention.

### FIELD OF THE INVENTION

This invention relates to electrochemical devices, such as lithium-ion battery electrodes, thin film lithium-ion batteries, and lithium-ion batteries including these electrodes.

### BACKGROUND

Lithium-ion batteries have become a vital part of the way that society stores and uses electrical energy. Among the myriad applications, electric vehicles (EVs) are rapidly becoming the dominant source of demand for rechargeable batteries. Despite significant advances over the past several years, further improvements in charging rate and energy density remain key challenges. Increasing energy density and charging rate without sacrificing cycle life, safety, or cost is a pressing challenge for battery development.

State-of-the-art electrolytes for lithium-ion batteries contain a mixture of organic solvents including ethylene carbonate (EC). The EC is often considered a requirement in order to form a stable solid electrolyte interphase on graphite electrodes. Solid electrolyte interphases begin forming on the anode and the cathode during a first charge of the formation process of a lithium ion battery having an anode comprising graphite and using a liquid electrolyte comprising a lithium salt (e.g., LiPF₆) and ethylene carbonate solvent. As lithiated carbons are not stable in air, this type of lithium ion battery is assembled in its discharged unformed state which means with a graphite anode and lithiated positive cathode materials. The electrolyte including ethylene carbonate solvent is thermodynamically unstable at low and very high potentials vs. Li/Li⁺. Therefore, when the anode is exposed to the electrolyte solution including ethylene carbonate solvent and a first charging current of the formation process is applied to the battery, immediate reactions between lithium ions and ethylene carbonate solvent are carried out. The insoluble products of the parasitic reactions between lithium ions, anions, and the ethylene carbonate solvent deposit on the anode surface, and are regarded as the solid electrolyte interphase (SEI). The SEI layer imparts kinetic stability to the electrolyte against further reductions in the successive cycles and thereby ensures good cyclability of the electrode. It has been reported that SEI thickness may vary from few angstroms to tens or hundreds of angstroms. Studies suggest the SEI on a graphitic anode to be a dense layer of inorganic components close to the carbon of the anode, followed by a porous organic or polymeric layer close to the electrolyte phase. The actual surface chemistry of the SEI layer in a given cell is typically obtained by characterization methods such as Fourier transform infrared spectroscopy (FTIR) and X-ray photoelectron spectroscopy (XPS).

Thus, during the initial formation cycling at the manufacturing facility, the ethylene carbonate is reduced, and forms a passivating SEI layer on the electrode surface. The SEI layer imparts kinetic stability to the electrolyte against further reductions in the successive cycles and thereby ensures good cyclability of the electrode. However, formation cycling to form an SEI is costly in that it may comprise about one-third of manufacturing costs for lithium-ion batteries.

As an alternative to electrolytes including ethylene carbonate, it has been reported that ethylene carbonate-free electrolytes may offer superior high-voltage stability and ionic conductivity for lithium-ion batteries. However, the use of ethylene carbonate-free electrolytes typically results in reduced cycle life when graphite electrodes are utilized.

What is needed therefore are methods for improving the cycle life of lithium-ion batteries and for reducing manufacturing costs for lithium-ion batteries.

### SUMMARY OF THE INVENTION

We have developed a coating process that deposits a protective coating on the surface of a lithium-ion battery electrode prior to cell assembly. The coating, deposited by atomic layer deposition (ALD), is comprised of a lithium borate-lithium carbonate (LBCO) solid electrolyte. This coating passivates the electrode surface, preventing side reactions during charging and increasing first cycle efficiency. Eliminating SEI formation also reduces the need for slow, costly preconditioning using a formation current to be performed following lithium-ion battery cell assembly. The LBCO coating also improves wetting of the electrolyte into the electrode, reducing time needed before preconditioning can commence. The LBCO coating enables the use of EC-free electrolytes with no additives, improving cycling stability at high voltages for lithium-ion batteries.

In one aspect, the present disclosure provides a method for forming an electrochemical device. The method can comprise: (a) exposing anode material particles to a lithium-containing precursor followed by an oxygen-containing precursor to form a coating on the anode material particles; (b) forming a slurry comprising the coated anode material particles; (c) casting the slurry on a surface to form a layer; (d) calendering the layer to form an anode of the electrochemical device; (e) positioning a separator between the anode and a cathode to form a cell structure; and (f) positioning the cell structure in a liquid electrolyte, wherein the electrolyte is essentially free of a solvent that forms a solid electrolyte interphase on the anode. An example solvent that would form a solid electrolyte interphase on the anode may be a carbonate such as ethylene carbonate. Step (a) can further comprise exposing the anode material particles to a boron-containing precursor followed by the oxygen-containing precursor to form the coating on the anode material particles. In the method, the coating can comprise Li₃BO₃—Li₂CO₃.

In another aspect, the present disclosure provides a method for forming an electrochemical device. The method can comprise: (a) forming a mixture comprising anode material particles; (b) casting and/or calendering the mixture such that a porous structure is formed; (c) exposing the porous structure to a lithium-containing precursor followed by an oxygen-containing precursor to form a coating on the porous structure thereby forming an anode; (d) positioning a separator between the anode and a cathode to form a cell structure; and (e) positioning the cell structure in a liquid electrolyte, wherein the electrolyte is essentially free of a solvent that forms a solid electrolyte interphase on the anode. An example solvent that would form a solid electrolyte interphase on the anode may be a carbonate such as ethylene carbonate. Step (c) can further comprise exposing the porous structure to a boron-containing precursor followed by the oxygen-containing precursor to form the coating on the porous structure. In the method, the coating can comprise Li₃BO₃—Li₂CO₃.

In yet another aspect, the present disclosure provides a method for forming an electrochemical device. The method can comprise: (a) exposing cathode material particles to a lithium-containing precursor followed by an oxygen-containing precursor to form a coating on the cathode material particles; (b) forming a slurry comprising the coated cathode material particles; (c) casting the slurry on a surface to form a layer; (d) calendering the layer to form an cathode of the electrochemical device; (e) positioning a separator between the cathode and an anode to form a cell structure; and (f) positioning the cell structure in a liquid electrolyte, wherein the electrolyte is essentially free of a solvent that forms a solid electrolyte interphase on the cathode. An example solvent that would form a solid electrolyte interphase on the cathode may be a carbonate such as ethylene carbonate. Step (a) can further comprise exposing the cathode material particles to a boron-containing precursor followed by the oxygen-containing precursor to form the coating on the cathode material particles. In the method, the coating can comprise Li₃BO₃—Li₂CO₃.

In still another aspect, the present disclosure provides a method for forming an electrochemical device. The method can comprise: (a) forming a mixture comprising cathode material particles; (b) casting and/or calendering the mixture such that a porous structure is formed; (c) exposing the porous structure to a lithium-containing precursor followed by an oxygen-containing precursor to form a coating on the porous structure thereby forming a cathode; (d) positioning a separator between the cathode and an anode to form a cell structure; and (e) positioning the cell structure in a liquid electrolyte, wherein the electrolyte is essentially free of a solvent that forms a solid electrolyte interphase on the cathode. An example solvent that would form a solid electrolyte interphase on the cathode may be a carbonate such as ethylene carbonate. Step (c) can further comprise exposing the porous structure to a boron-containing precursor followed by the oxygen-containing precursor to form the coating on the porous structure. In the method, the coating can comprise Li₃BO₃—Li₂CO₃.

It is an advantage of the invention to provide a method that eliminates the costly natural SEI formation required during formation processes for lithium ion batteries having an anode comprising graphite and a liquid electrolyte comprising an ethylene carbonate solvent.

It is another advantage of the invention to provide a method that eliminates the natural SEI formation required during formation processes for lithium ion batteries having a cathode and a liquid electrolyte comprising an ethylene carbonate solvent.

It is still another advantage of the invention to provide a method that increases Coulombic efficiency after multiple cycles for lithium ion batteries that use ethylene carbonate-free electrolytes.

It is yet another advantage of the invention to provide a method that enables the use of lower N:P ratios in a lithium ion battery wherein the N:P ratio is defined as the ratio of the reversible capacity (N) of the negative electrode to the reversible capacity (P) of the positive electrode.

It is still another advantage of the invention to provide a method that provides a larger improvement to SEI stability than previously reported approaches such as the use of a vinylene carbonate additive.

It is yet another advantage of the invention to provide a method that improves the high temperature operation of a lithium ion battery in that an electrolyte coating passivates the electrode and suppresses electrolyte interphase side reactions, improving capacity retention.

The foregoing and other aspects and advantages of the invention will appear from the following description. In the description, reference is made to the accompanying drawings which form a part hereof, and in which there is shown by way of illustration example embodiments of the invention. Such embodiments do not necessarily represent the full scope of the invention, however, and reference is made therefore to the claims and herein for interpreting the scope of the invention.

### BRIEF DESCRIPTION OF DRAWINGS

The patent or application file contains at least one drawing executed in color. Copies of this patent or patent application publication with color drawing(s) will be provided by the Office upon request and payment of the necessary fee.

FIG. 1 is a schematic of a thin film lithium-ion battery.

FIG. 2 depicts a process flowchart of a method of making a lithium borate-carbonate film.

FIG. 3 depicts in panels a & b, that SEI formation on graphite is eliminated by LBCO coating in an ethylene carbonate (EC)-free electrolyte, and in panel c, a Coulombic efficiency of an initial preconditioning cycle.

FIG. 4 depicts in panel a, the capillary rise of a carbonate-based electrolyte through a calendered electrode measured over time with optical image analysis, and in panels b & c, images at the beginning and at 200 seconds after dipping the electrodes into the electrolyte.

FIG. 5 depicts in panels a & b, the discharge capacity for a 4.3 V and a 4.5 V upper cutoff voltage with and without a LBCO coating, and in panel c, the average Coulombic efficiency of the first 50 cycles at 1 C/1 C charge/discharge rates for a 4.3 V and a 4.5 V upper voltage cutoff.

FIG. 6 depicts X-ray photoelectron spectroscopy data for electrodes in the following combinations of electrode and electrolyte: (i) uncoated electrode (Ctrl)−ethylene carbonate/ethyl methyl carbonate+vinylene carbonate; (ii) uncoated electrode (Ctrl)−ethyl methyl carbonate; (iii) LBCO coated electrode−ethylene carbonate/ethyl methyl carbonate+vinylene carbonate; and (iv) LBCO coated electrode−ethyl methyl carbonate.

FIG. 7 depicts discharge capacity versus cycle number for cells having the following combinations of electrode and electrolyte: (i) uncoated electrode (Control)−ethyl methyl carbonate; (ii) LBCO coated electrode−ethyl methyl carbonate; (iii) uncoated electrode (Control)−ethyl methyl carbonate+vinylene carbonate; and (iv) uncoated electrode (Control)−ethylene carbonate/ethyl methyl carbonate+vinylene carbonate.

The invention will be better understood and features, aspects and advantages other than those set forth above will become apparent when consideration is given to the following detailed description thereof. Such detailed description makes reference to the drawings.

### DETAILED DESCRIPTION OF THE INVENTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. Skilled artisans will recognize the examples provided herein have many useful alternatives and fall within the scope of embodiments of the invention.

Although the systems and methods introduced herein are often described for use in an electrochemical cell or battery, one of skill in the art will appreciate that these teachings can be used for various applications (e.g. sensors, fuel cells).

As used herein, “formation” is the process that includes the step of charging of the battery for the first time. This charging may be accomplished using a “formation current”. An “unformed” structure has not yet undergone the first charging of the “formation” process.

One embodiment of the invention provides a method for forming an electrochemical device. The method can comprise: (a) exposing anode material particles to a lithium-containing precursor followed by an oxygen-containing precursor to form a coating on the anode material particles; (b) forming a slurry comprising the coated anode material particles; (c) casting the slurry on a surface to form a layer; (d) calendering the layer to form an anode of the electrochemical device; (e) positioning a separator between the anode and a cathode to form a cell structure; and (f) positioning the cell structure in a liquid electrolyte, wherein the electrolyte is essentially free of a solvent that forms a solid electrolyte interphase on the anode. An example solvent that would form a solid electrolyte interphase on the anode may be a carbonate such as ethylene carbonate. Step (a) can further comprise exposing the anode material particles to a boron-containing precursor followed by the oxygen-containing precursor to form the coating on the anode material particles. In the method, the coating can comprise Li₃BO₃—Li₂CO₃.

In this embodiment of the method, the lithium-containing precursor can comprise a lithium alkoxide. The boron-containing precursor can comprise a boron alkoxide. The oxygen-containing precursor can be selected from the group consisting of ozone, water, oxygen plasma, ammonium hydroxide, oxygen, and mixtures thereof. The lithium-containing precursor, the boron-containing precursor, and the oxygen-containing precursor can be in a gaseous state.

In this embodiment of the method, the anode material particles can be graphite particles. The cathode can comprise cathode material particles selected from the group consisting of lithium metal oxides wherein the metal is one or more of aluminum, cobalt, iron, manganese, nickel, vanadium; and the liquid electrolyte can comprise a lithium compound in an organic solvent.

In this embodiment of the method, the method can further comprise applying a formation current to the cell structure in a first cycle of a formation process, wherein a Coulombic efficiency of the cell structure after the first cycle is greater than 80%. In one embodiment of the method, the method can further comprise applying the formation current to the cell structure in additional cycles of the formation process such that a total cycles of the first cycle and the additional cycles is at least fifty cycles, wherein an average Coulombic efficiency after applying the formation current for the total cycles is greater than 99.5%.

In this embodiment of the method, the coating can be a film having a thickness of 0.1 to 50 nanometers. Step (a) can occur at a temperature between 50° C. and 280° C.

In this embodiment of the method, the liquid electrolyte can comprise a lithium compound in an organic solvent. The lithium compound can be selected from LiPF₆, LiBF₄, LiClO₄, lithium bis(fluorosulfonyl)imide (LiFSI), LiN(CF₃SO₂)₂ (LiTFSI), and LiCF₃SO₃ (LiTf), and the organic solvent can be selected from carbonate based solvents, ether based solvents, ionic liquids, and mixtures thereof. The organic solvent can be selected from the group consisting of dimethyl carbonate, diethyl carbonate, ethyl methyl carbonate, dipropyl carbonate, methylpropyl carbonate, ethylpropyl carbonate, methylethyl carbonate, propylene carbonate, butylene carbonate, and mixtures thereof. The liquid electrolyte can comprise LiPF₆ and ethyl methyl carbonate.

Another embodiment of the invention provides a method for forming an electrochemical device. The method can comprise: (a) forming a mixture comprising anode material particles; (b) casting and/or calendering the mixture such that a porous structure is formed; (c) exposing the porous structure to a lithium-containing precursor followed by an oxygen-containing precursor to form a coating on the porous structure thereby forming an anode; (d) positioning a separator between the anode and a cathode to form a cell structure; and (e) positioning the cell structure in a liquid electrolyte, wherein the electrolyte is essentially free of a solvent that forms a solid electrolyte interphase on the anode. An example solvent that would form a solid electrolyte interphase on the anode may be a carbonate such as ethylene carbonate. Step (c) can further comprise exposing the porous structure to a boron-containing precursor followed by the oxygen-containing precursor to form the coating on the porous structure. In the method, the coating can comprise Li₃BO₃—Li₂CO₃.

In this embodiment of the method, the lithium-containing precursor can comprise a lithium alkoxide. The boron-containing precursor can comprise a boron alkoxide. The oxygen-containing precursor can be selected from the group consisting of ozone, water, oxygen plasma, ammonium hydroxide, oxygen, and mixtures thereof. The lithium-containing precursor, the boron-containing precursor, and the oxygen-containing precursor can be in a gaseous state.

In this embodiment of the method, the anode material particles can be graphite particles. The cathode can comprise cathode material particles selected from the group consisting of lithium metal oxides wherein the metal is one or more of aluminum, cobalt, iron, manganese, nickel, vanadium; and the liquid electrolyte can comprise a lithium compound in an organic solvent.

In this embodiment of the method, the method can further comprise applying a formation current to the cell structure in a first cycle of a formation process, wherein a Coulombic efficiency of the cell structure after the first cycle is greater than 80%. In one embodiment of the method, the method can further comprise applying the formation current to the cell structure in additional cycles of the formation process such that a total cycles of the first cycle and the additional cycles is at least fifty cycles, wherein an average Coulombic efficiency after applying the formation current for the total cycles is greater than 99.5%.

In this embodiment of the method, the coating can be a film having a thickness of 0.1 to 50 nanometers. Step (a) can occur at a temperature between 50° C. and 280° C.

In this embodiment of the method, the liquid electrolyte can comprise a lithium compound in an organic solvent. The lithium compound can be selected from LiPF₆, LiBF₄, LiClO₄, lithium bis(fluorosulfonyl)imide (LiFSI), LiN(CF₃SO₂)₂ (LiTFSI), and LiCF₃SO₃ (LiTf), and the organic solvent can be selected from carbonate based solvents, ether based solvents, ionic liquids, and mixtures thereof. The organic solvent can be selected from the group consisting of dimethyl carbonate, diethyl carbonate, ethyl methyl carbonate, dipropyl carbonate, methylpropyl carbonate, ethylpropyl carbonate, methylethyl carbonate, propylene carbonate, butylene carbonate, and mixtures thereof. The liquid electrolyte can comprise LiPF₆ and ethyl methyl carbonate.

Yet another embodiment of the invention provides a method for forming an electrochemical device. The method can comprise: (a) exposing cathode material particles to a lithium-containing precursor followed by an oxygen-containing precursor to form a coating on the cathode material particles; (b) forming a slurry comprising the coated cathode material particles; (c) casting the slurry on a surface to form a layer; (d) calendering the layer to form an cathode of the electrochemical device; (e) positioning a separator between the cathode and an anode to form a cell structure; and (f) positioning the cell structure in a liquid electrolyte, wherein the electrolyte is essentially free of a solvent that forms a solid electrolyte interphase on the cathode. An example solvent that would form a solid electrolyte interphase on the cathode may be a carbonate such as ethylene carbonate. Step (a) can further comprise exposing the cathode material particles to a boron-containing precursor followed by the oxygen-containing precursor to form the coating on the cathode material particles. In the method, the coating can comprise Li₃BO₃—Li₂CO₃.

In this embodiment of the method, the lithium-containing precursor can comprise a lithium alkoxide. The boron-containing precursor can comprise a boron alkoxide. The oxygen-containing precursor can be selected from the group consisting of ozone, water, oxygen plasma, ammonium hydroxide, oxygen, and mixtures thereof. The lithium-containing precursor, the boron-containing precursor, and the oxygen-containing precursor can be in a gaseous state.

In this embodiment of the method, the cathode material particles can be selected from the group consisting of lithium metal oxides wherein the metal is one or more of aluminum, cobalt, iron, manganese, nickel, vanadium, and lithium-containing phosphates having a general formula LiMPO₄ wherein M is one or more of cobalt, iron, manganese, and nickel. In this embodiment of the method, the cathode material particles can be selected from the group consisting of cathode material particles having a formula LiNiₐMn_{b}Co_{c}O₂, wherein a+b+c=1 and a:b:c=(NMC 111), a:b:c=4:3:3 (NMC 433), a:b:c=5:2:2 (NMC 522), a:b:c=5:3:2 (NMC 532), a:b:c=6:2:2 (NMC 622), or a:b:c=8:1:1 (NMC 811).

In this embodiment of the method, the cathode material particles can be selected from the group consisting of lithium metal oxides wherein the metal is one or more of aluminum, cobalt, iron, manganese, nickel, vanadium; the anode can comprise graphite particles; and the liquid electrolyte can comprise a lithium compound in an organic solvent.

In this embodiment of the method, the method can further comprise applying a formation current to the cell structure in a first cycle of a formation process, wherein a Coulombic efficiency of the cell structure after the first cycle is greater than 80%. In one embodiment of the method, the method can further comprise applying the formation current to the cell structure in additional cycles of the formation process such that a total cycles of the first cycle and the additional cycles is at least fifty cycles, wherein an average Coulombic efficiency after applying the formation current for the total cycles is greater than 99.5%.

In this embodiment of the method, the coating can be a film having a thickness of 0.1 to 50 nanometers. Step (a) can occur at a temperature between 50° C. and 280° C.

In this embodiment of the method, the liquid electrolyte can comprise a lithium compound in an organic solvent. The lithium compound can be selected from LiPF₆, LiBF₄, LiClO₄, lithium bis(fluorosulfonyl)imide (LiFSI), LiN(CF₃SO₂)₂ (LiTFSI), and LiCF₃SO₃ (LiTf), and the organic solvent can be selected from carbonate based solvents, ether based solvents, ionic liquids, and mixtures thereof. The organic solvent can be selected from the group consisting of dimethyl carbonate, diethyl carbonate, ethyl methyl carbonate, dipropyl carbonate, methylpropyl carbonate, ethylpropyl carbonate, methylethyl carbonate, propylene carbonate, butylene carbonate, and mixtures thereof. The liquid electrolyte can comprise LiPF₆ and ethyl methyl carbonate.

Still another embodiment of the invention provides a method for forming an electrochemical device. The method can comprise: (a) forming a mixture comprising cathode material particles; (b) casting and/or calendering the mixture such that a porous structure is formed; (c) exposing the porous structure to a lithium-containing precursor followed by an oxygen-containing precursor to form a coating on the porous structure thereby forming a cathode; (d) positioning a separator between the cathode and an anode to form a cell structure; and (e) positioning the cell structure in a liquid electrolyte, wherein the electrolyte is essentially free of a solvent that forms a solid electrolyte interphase on the cathode. An example solvent that would form a solid electrolyte interphase on the cathode may be a carbonate such as ethylene carbonate. Step (c) can further comprise exposing the porous structure to a boron-containing precursor followed by the oxygen-containing precursor to form the coating on the porous structure. In the method, the coating can comprise Li₃BO₃—Li₂CO₃.

In this embodiment of the method, the lithium-containing precursor can comprise a lithium alkoxide. The boron-containing precursor can comprise a boron alkoxide. The oxygen-containing precursor can be selected from the group consisting of ozone, water, oxygen plasma, ammonium hydroxide, oxygen, and mixtures thereof. The lithium-containing precursor, the boron-containing precursor, and the oxygen-containing precursor can be in a gaseous state.

In this embodiment of the method, the cathode material particles can be selected from the group consisting of lithium metal oxides wherein the metal is one or more of aluminum, cobalt, iron, manganese, nickel, vanadium, and lithium-containing phosphates having a general formula LiMPO₄ wherein M is one or more of cobalt, iron, manganese, and nickel. In this embodiment of the method, the cathode material particles can be selected from the group consisting of cathode material particles having a formula LiNiₐMn_{b}Co_{c}O₂, wherein a+b+c=1 and a:b:c=(NMC 111), a:b:c=4:3:3 (NMC 433), a:b:c=5:2:2 (NMC 522), a:b:c=5:3:2 (NMC 532), a:b:c=6:2:2 (NMC 622), or a:b:c=8:1:1 (NMC 811).

In this embodiment of the method, the cathode material particles can be selected from the group consisting of lithium metal oxides wherein the metal is one or more of aluminum, cobalt, iron, manganese, nickel, vanadium; the anode can comprise graphite particles; and the liquid electrolyte can comprise a lithium compound in an organic solvent.

In this embodiment of the method, the method can further comprise applying a formation current to the cell structure in a first cycle of a formation process, wherein a Coulombic efficiency of the cell structure after the first cycle is greater than 80%. In one embodiment of the method, the method can further comprise applying the formation current to the cell structure in additional cycles of the formation process such that a total cycles of the first cycle and the additional cycles is at least fifty cycles, wherein an average Coulombic efficiency after applying the formation current for the total cycles is greater than 99.5%.

In this embodiment of the method, the coating can be a film having a thickness of 0.1 to 50 nanometers. Step (a) can occur at a temperature between 50° C. and 280° C.

In this embodiment of the method, the liquid electrolyte can comprise a lithium compound in an organic solvent. The lithium compound can be selected from LiPF₆, LiBF₄, LiClO₄, lithium bis(fluorosulfonyl)imide (LiFSI), LiN(CF₃SO₂)₂ (LiTFSI), and LiCF₃SO₃ (LiTf), and the organic solvent can be selected from carbonate based solvents, ether based solvents, ionic liquids, and mixtures thereof. The organic solvent can be selected from the group consisting of dimethyl carbonate, diethyl carbonate, ethyl methyl carbonate, dipropyl carbonate, methylpropyl carbonate, ethylpropyl carbonate, methylethyl carbonate, propylene carbonate, butylene carbonate, and mixtures thereof. The liquid electrolyte can comprise LiPF₆ and ethyl methyl carbonate.

The invention provides a method that eliminates the costly natural SEI formation required during formation processes for lithium ion batteries having an anode comprising graphite and a liquid electrolyte comprising an ethylene carbonate solvent. In embodiments of the method of the invention, the electrolyte is essentially free of a solvent that forms a solid electrolyte interphase (SEI) on the anode and/or the cathode. In another embodiment of the method of the invention, the electrolyte is essentially free of a solvent that forms a solid electrolyte interphase on the anode and/or cathode such as a carbonate that would form a solid electrolyte interphase on the anode and/or cathode. In another embodiment of the method of the invention, the electrolyte is essentially free of ethylene carbonate that would form a solid electrolyte interphase on the anode and/or cathode. As used herein, “essentially free of a solvent that forms a solid electrolyte interphase” means that the solvent that would form a solid electrolyte interphase is not added to the electrolyte, but the solvent that would form a solid electrolyte interphase may be present as an impurity or undesired contaminant in the electrolyte. For example, “essentially free of ethylene carbonate” means that ethylene carbonate is not added to the electrolyte, but ethylene carbonate may be present as an impurity or undesired contaminant in the electrolyte.

One embodiment described herein relates to a method for creating a lithium-ion-battery using atomic layer deposition (ALD). The lithium-ion battery can be a liquid-electrolyte-based lithium-ion battery.

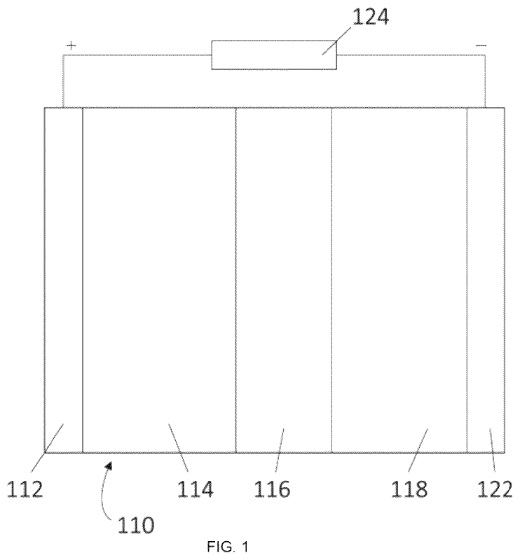

In one non-limiting example application, atomic layer deposition can be used in forming a thin film lithium-ion battery 110 as depicted in FIG. 1. The thin film lithium-ion battery 110 includes a current collector 112 (e.g., aluminum) in contact with a cathode 114. The separator 116 is arranged between the cathode 114 and an anode 118, which is in contact with a current collector 122 (e.g., aluminum). The current collectors 112 and 122 of the thin film lithium-ion battery 110 may be in electrical communication with an electrical component 124. The electrical component 124 could place the thin film lithium-ion battery 110 in electrical communication with an electrical load that discharges the battery or a charger that charges the lithium-ion battery.

The electrolyte for the battery 110 may be a liquid electrolyte. The liquid electrolyte of the electrochemical cell may comprise a lithium compound in an organic solvent. The lithium compound may be selected from LiPF₆, LiBF₄, LiClO₄, lithium bis(fluorosulfonyl)imide (LiFSI), LiN(CF₃SO₂)₂ (LiTFSI), and LiCF₃SO₃ (LiTf). The organic solvent may be selected from carbonate based solvents, ether based solvents, ionic liquids, and mixtures thereof. The carbonate based solvent may be selected from the group consisting of dimethyl carbonate, diethyl carbonate, ethyl methyl carbonate, dipropyl carbonate, methylpropyl carbonate, ethylpropyl carbonate, methylethyl carbonate, propylene carbonate, and butylene carbonate; and the ether based solvent is selected from the group consisting of diethyl ether, dibutyl ether, monoglyme, diglyme, tetraglyme, 2-methyltetrahydrofuran, tetrahydrofuran, 1,3-dioxolane, 1,2-dimethoxyethane, and 1,4-dioxane. The liquid electrolyte is essentially free of a solvent that would form a solid electrolyte interphase (SEI) on the anode and/or the cathode.

The first current collector 112 and the second current collector 122 can comprise a conductive metal or any suitable conductive material. In some embodiments, the first current collector 112 and the second current collector 122 comprise aluminum, nickel, copper, combinations and alloys thereof. In other embodiments, the first current collector 112 and the second current collector 122 have a thickness of 0.1 microns or greater. It is to be appreciated that the thicknesses depicted in FIG. 1 are not drawn to scale, and that the thickness of the first current collector 112 and the second current collector 122 may be different.

A suitable active material for the cathode 114 of the thin film lithium-ion battery 110 is a lithium host material capable of storing and subsequently releasing lithium ions. An example cathode active material is a lithium metal oxide wherein the metal is one or more aluminum, cobalt, iron, manganese, nickel and vanadium. Non-limiting example lithium metal oxides are LiCoO₂ (LCO), LiFeO₂, LiMnO₂ (LMO), LiMn₂O₄, LiNiO₂ (LNO), LiNiₓCo_{y}O₂, LiMnₓCo_{y}O₂, LiMnₓNi_{y}O₂, LiMnₓNi_{y}O₄, LiNiₓCo_{y}Al_{z}O₂, LiNi_{1/3}Mn_{1/3}Co_{1/3}O₂ and others. Another example of cathode active materials is a lithium-containing phosphate having a general formula LiMPO₄ wherein M is one or more of cobalt, iron, manganese, and nickel, such as lithium iron phosphate (LFP) and lithium iron fluorophosphates. Another example of a cathode active material is V₂O₅. Many different elements, e.g., Co, Mn, Ni, Cr, Al, or Li, may be substituted or additionally added into the structure to influence electronic conductivity, ordering of the layer, stability on delithiation and cycling performance of the cathode materials. The cathode active material can be selected from the group consisting of cathode material particles having a formula LiNiₐMn_{b}Co_{c}O₂, wherein a+b+c=1 and a:b:c=(NMC 111), a:b:c=4:3:3 (NMC 433), a:b:c=5:2:2 (NMC 522), a:b:c=5:3:2 (NMC 532), a:b:c=6:2:2 (NMC 622), or a:b:c=8:1:1 (NMC 811). The cathode active material can be a mixture of any number of these cathode active materials. In other embodiments, a suitable material for the cathode 114 of the thin film lithium-ion battery 110 is porous carbon (for a lithium air battery), or a sulfur containing material (for a lithium sulfur battery).

In some embodiments, a suitable active material for the anode 118 of the thin film lithium-ion battery 110 comprises a material selected from graphite, lithium titanate, hard carbon, tin/cobalt alloy, silicon, and silicon-carbon composites.

The thin film lithium-ion battery 110 comprises a separator 116 located between the cathode 114 and the anode 118. An example separator 116 material for the thin film lithium-ion battery 110 can a permeable polymer such as a polyolefin. Example polyolefins include polyethylene, polypropylene, and combinations thereof. The separator 116 may have a thickness in the range of 1 to 200 nanometers, or in the range of 40 to 1000 nanometers.

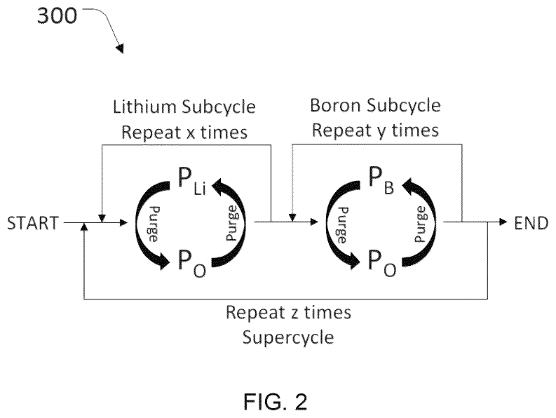

FIG. 2 depicts a process flowchart 300 for a method of making an ionically conductive film using an atomic layer deposition process of the present invention. The method can comprise a first step in which a substrate is exposed to a lithium-containing precursor, which reacts with the surface and the excess and product species are removed from the surface. Subsequently, an oxygen-containing precursor is exposed to the surface, and another reaction occurs. This represents single “subcycle”, which can be repeated x times, where x may be any integer from 1 to 10. Then another subcycle where a boron-containing precursor is exposed to the substrate followed by an oxygen-containing precursor can be repeated y times, where y may be any integer from 1 to 10. This entire “supercycle” can then be repeated z times to deposit a layer of the desired thickness. The value of z may be an integer between 1 and 5000, between 10 and 1000, or between 100 and 500. This process may result in the formation of a film comprising lithium, boron, and oxygen, and in some cases carbon. The precursors may be in a gaseous state. The subcycles may occur in either order to start the supercycle.

The sequential reactions can be separated either chronologically or spatially.

The lithium-containing precursor may be selected from the group consisting of lithium tert-butoxide (LiOtBu), 2,2,6,6-tetramethyl-3,5-heptanedionate (Li(thd)), and lithium hexamethyldisilazide (LiHMDS). The lithium-containing precursor may be a lithium alkoxide such as lithium tert-butoxide. The boron-containing precursor may be selected from the group consisting of triisopropylborate (TIB), boron tribromide (BBr₃), boron trichloride (BCl₃), triethylboron (TEB), tris(ethyl-methylamino) borane, trichloroborazine (TCB), tris(dimethylamido)borane (TDMAB), trimethylborate (TMB), diboron tetrafluoride (B₂F₄). The boron-containing precursor may be a boron alkoxide such as triisopropylborate. The oxygen-containing precursor may be selected from the group consisting of ozone (O₃), water (H₂O), oxygen plasma (O₂(p)), ammonium hydroxide (NH₄OH), Oxygen (O₂). The oxygen-containing precursor may be ozone.

The film formed by the method 300 is an artificial solid-electrolyte interphase (a-SEI). The conformal ALD film is shown to eliminate the costly natural SEI formation required during formation processes for lithium ion batteries having an anode comprising graphite and a liquid electrolyte comprising an ethylene carbonate solvent. Also, cells with graphite electrodes coated with the film exhibit superior rate capability and stability during fast charging for lithium ion batteries that use ethylene carbonate-free electrolytes.

The film formed by the method 300 may have a thickness between 20 and 100 nanometers, between 0.1 and 1000 nanometers, between 1 and 100 nanometers, between 20 and 80 nanometers, or between 0.1 and 50 nanometers, or between 0.1 and 35 nanometers. The ionically conductive film layer may have a total area specific-resistance (ASR) of less than 450 ohm cm², or is less than 400 ohm cm², or is less than 350 ohm cm², or is less than 300 ohm cm², or is less than 250 ohm cm², or is less than 200 ohm cm², or is less than 150 ohm cm², or is less than 100 ohm cm², or is less than 75 ohm cm², or is less than 50 ohm cm², or is less than 25 ohm cm², or is less than 10 ohm cm², or less than 5 Ω-cm².

The film formed by the method 300 may have an ionic conductivity of greater than 1.0×10⁻⁷ S/cm, or greater than 1.0×10⁻⁶ S/cm, or greater than 1.5×10⁻⁶ S/cm, or greater than 2.0×10⁻⁶ S/cm, or greater than 2.2×10⁻⁶ S/cm at standard temperature and pressure. The ionically conductive layer may have an ionic transference number of greater than 0.9999 from 0-6 volts vs lithium metal. The first step and second step may occur in any order and at a temperature between 50° C. and 280° C., or between 180° C. and 280° C., or between 200° C. and 220° C.

The substrate of the method of 300 can be an anode or a cathode. The substrate of the method of 300 can be planar or have a three dimensional structure, such as a corrugated structure.

### Forming an Electrode for an Electrochemical Device

The present disclosure relates to forming an electrode for use in an electrochemical device, such as a lithium ion battery. In one embodiment, the method for forming an electrode includes depositing a film of the present disclosure on a powdered electrode material, and forming a slurry comprising the coated electrode material. The slurry is then cast on a surface to form a layer, and the layer is dried and calendered to form the electrode. The electrode material may be any of the anode materials or cathode materials described above.

In another embodiment, the electrode may be produced by forming a slurry comprising an electrode material, casting the slurry on a surface to form a layer, and drying and calendering the layer. A film of the present disclosure is then deposited on a surface of the dried and calendered layer to form a thin film to complete forming the electrode.

In another embodiment, the electrode may be produced by forming a slurry comprising an electrode material, casting the slurry on a surface to form a layer, calendering the layer, and depositing a film of the present disclosure on the layer. The film coated layer is then dried and calendered to complete forming the electrode.

The slurry as described in any of the preceding embodiments may be formed by mixing the electrode material or coated electrode material with an aqueous or organic solvent. Suitable solvents may include N-methyl-2-pyrrolidone (NMP) or other suitable alternatives that would be readily understood to those skilled in the art. A binder may also be added to the slurry, such as polyvinylidene fluoride (PVDF) or any suitable alternative that would be readily understood to those skilled in the art. A conductive additive, such as a metallic powder or carbon black, may also be added to the slurry.

The layer of the electrode as discussed in any of the preceding embodiments may be dried and calendered to have a thickness that ranges between 1 to 200 microns. In some embodiments, the thickness of the electrode is less than 175 microns, or less than 150 microns, or less than 125 microns, or less than 100 microns, or less than 75 microns, or less than 50 microns.

The thin film coating on the surfaces of the electrode material as discussed in any of the preceding embodiments may have a thickness that ranges from 0.1 to 50 nanometers. One example thin film coating comprises Li₃BO₃—Li₂CO₃.

### EXAMPLES

The following Examples are provided in order to demonstrate and further illustrate certain embodiments and aspects of the present invention and are not to be construed as limiting the scope of the invention. The statements provided in the examples are presented without being bound by theory.

### Example 1

### A. Overview of Example 1

Enabling fast-charging (≥4 C) of lithium-ion batteries is an important challenge to accelerate the adoption of electric vehicles. (The C-rate specifies the speed a battery is charged or discharged. For example, at 1 C, the battery is charged and discharged at a current that is par with the amp-hour (Ah) rating of the battery. At 4 C, the battery is charged and discharged at a current that is four-times the 1 C rate.) However, the desire to maximize energy density has driven the use of increasingly thick electrodes, which hinders power density. Herein, atomic layer deposition was used to coat a single-ion conducting solid electrolyte (Li₃BO₃—Li₂CO₃) film onto post-calendered graphite electrodes, forming an artificial solid-electrolyte interphase (a-SEI). When compared to uncoated control electrodes, the solid electrolyte coating: (1) eliminates natural SEI formation during preconditioning from a costly formation process; (2) increases a Coulombic efficiency of the cell after the first cycle of a formation process; and (3) increases an average Coulombic efficiency after applying the formation current for multiple cycles of a formation process.

Lithium-ion batteries (LIBs) have become a vital part of the way that society stores and uses electrical energy. Among the myriad applications, electric vehicles (EVs) are rapidly becoming the dominant source of demand for rechargeable batteries. Despite significant advances over the past several years, further improvements in charging rate remain key challenges. To date, a majority of work on fast charging of graphite aims to homogenize the current distribution throughout the electrode thickness by improving mass transport in the electrolyte.

While these works have shown great promise for enabling fast charging and have demonstrated the importance of mass transport, less attention has been paid to the role of the solid-electrolyte interphase (SEI) in determining fast-charge performance. In state-of-the-art LIBs, a mosaic SEI consisting of inorganic and organic species forms naturally during the initial charge due to electrolyte decomposition as the graphite electrode potential drops towards the equilibrium potential of Li metal (−3.04 V vs. SHE). [Refs. 1-3] The primary means of engineering the SEI has been through electrolyte modifications, which has proven to be a key enabler for the high Coulombic efficiency and long cycle-life of today's LIBs. [Ref. 4] The properties of the natural SEI are sufficient at low current densities, when the electrochemical potential remains >0 V vs. Li/Li+, but do not prevent Li plating during fast-charging.

While artificial SEI (a-SEI) coatings have been studied to improve interfacial stability, less attention has been paid to optimization of a-SEIs for fast charging. We have recently developed atomic layer deposition (ALD) processes for single-ion conducting solid electrolytes that are stable against Li. [Refs. 5-6] In particular, ALD of glassy Li₃BO₃—Li₂CO₃ (LBCO) solid electrolytes have shown to exhibit the properties listed above. LBCO films were shown to have the highest measured ionic conductivity of any ALD film reported to date (>2×10⁻⁶ S/cm at 30° C.), and are stable when cycled in contact with Li metal. [Ref. 7]

ALD affords unparalleled control of film thickness and conformality owing to the self-limiting nature of the surface reactions. ALD is a powerful means of interface modification for electrode materials in LIBs, but work to date has largely focused on coating cathodes to improve interface stability.

Herein we demonstrate the use of a single-ion conducting solid electrolyte (LBCO) coating on graphite electrodes. The conformal ALD film is shown to eliminate the costly natural SEI formation required during formation processes for lithium ion batteries having an anode comprising graphite and a liquid electrolyte comprising an ethylene carbonate solvent. Also, cells with graphite electrodes coated with the film exhibit superior rate capability and stability during fast charging for lithium ion batteries that use ethylene carbonate-free electrolytes. This Example 1 points to the key role of the SEI in limiting the fast-charge capability of LIBs.

### B. Experimental Methods

Electrode Fabrication: Graphite and NMC electrodes were fabricated using the pilot scale roll-to-roll battery manufacturing facilities at the University of Michigan Battery Lab, as reported previously. [Ref. 8] The graphite electrodes were fabricated with a total loading of 9.40 mg-cm⁻² including 94% natural graphite (battery grade, SLC1506T, Superior Graphite), 1% C65 conductive additive, and 5% CMC/SBR binder), resulting in a theoretical capacity of 3.18 mAh-cm⁻². The electrodes were calendered to a porosity of −32%. After coating, drying, calendaring, and punching, the full electrodes were moved into a Savannah S200 ALD reactor integrated into an argon glovebox for coating.

LiNi_{0.5}Mn_{0.3}Co_{0.2}O₂ (battery grade, NMC-532, Toda America) was used as the cathode material. The cathode formulation was 92 wt. % NMC-532, 4 wt. % C65 conductive additive, and 4 wt. % PVDF binder. The cathode slurry was cast onto aluminum foils (15 μm thick) with a total areal mass loading of 16.58 mg-cm⁻² and then calendered to 35% porosity. This yields an N:P ratio of 1.1-1.2.

Film Deposition and Characterization: The LBCO ALD film was deposited onto the graphite electrodes using a modified version of the previously reported ALD process. [Ref. 9] This process uses lithium tert-butoxide, triisopropyl borate, and ozone precursors. In this case, the lithium tert-butoxide pulse length was increased to 10 seconds, with a 20 seconds exposure, and the triisopropyl borate pulse was increased to 0.25 seconds, with 20 seconds exposure. These modifications were made to enable full coating of the high surface area electrode substrates. The deposition was conducted with a substrate temperature of 200° C. Film thickness was measured on Si wafer pieces placed adjacent to the graphite electrodes using spectroscopic ellipsometry. A Woollam M-2000 was used to collect data, which were then fit with a Cauchy layer on top of the native oxide of the Si. The LBCO ALD film thickness was approximately 20 nanometers.

Cell Assembly: 2032 coin cells were assembled by punching circular electrodes from the larger pieces of ALD-coated and control electrodes. These electrodes were placed into the cells, followed by Entek EPH separator, 75 μL of electrolyte (1M LiPF₆ in ethyl methyl carbonate), the NMC electrode, a stainless steel spacer, and a Belleville washer. Cells were crimped at a pressure of 1000 psi.

Electrochemical Characterization: Preconditioning and cycling were performed using a Landt 2001a battery testing system.

### C. Results and Discussion

We have developed a coating process that deposits a protective LBCO coating on the surface of the electrode prior to cell assembly. The LBCO coating, deposited by atomic layer deposition, is comprised of a lithium borate-lithium carbonate solid electrolyte.

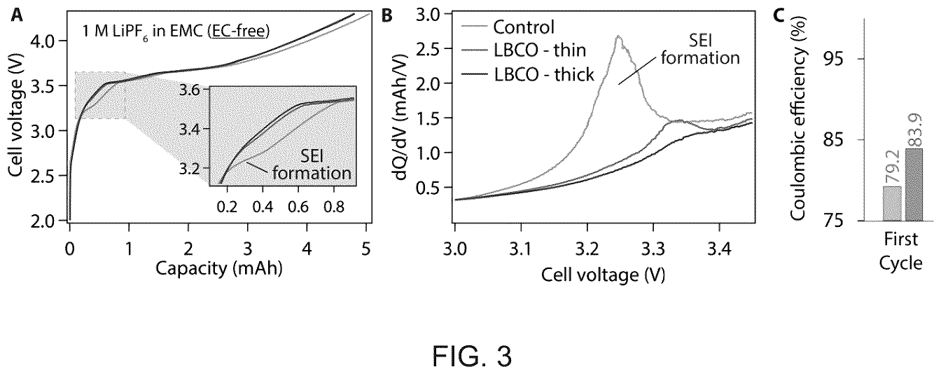

FIG. 3 depicts in panels a & b, that SEI formation on graphite is eliminated by LBCO coating in an ethylene carbonate (EC)-free electrolyte, and in panel c, the Coulombic efficiency of an initial preconditioning cycle. This coating passivates the electrode surface, preventing side reactions during charging and increasing first cycle efficiency (see FIG. 3, panels a-c).

Lithium ion batteries comprising graphite-based materials for a negative electrode are generally designed so that the reversible capacity (N) of the negative electrode is greater than the reversible capacity (P) of the positive electrode. An N:P ratio is then defined. Typically, this type of battery is designed exhibit an N:P ratio >1 (e.g., 1.05-1.3). Thus, excess graphite is placed in the cell in order to prevent the plating of lithium at the negative electrode during the charge and discharge cycles, which results in degradation of the battery. However, this excess of graphite leads to a decrease in the specific energy density of the cell. The LBCO artificial SEI reduces the impedance of the electrode compared to the natural SEI. As a result of this, the LBCO coating enables use of lower N:P ratios without lithium plating. This is related to FIG. 3. The 4.3 V and 4.5 V charging increases the accessed capacity of the positive electrode while leaving the capacity of the negative electrode unchanged. Therefore, this is decreasing the N:P ratio and increasing energy density. The result shows that the LBCO coating enables improved capacity retention under these conditions by preventing lithium plating.

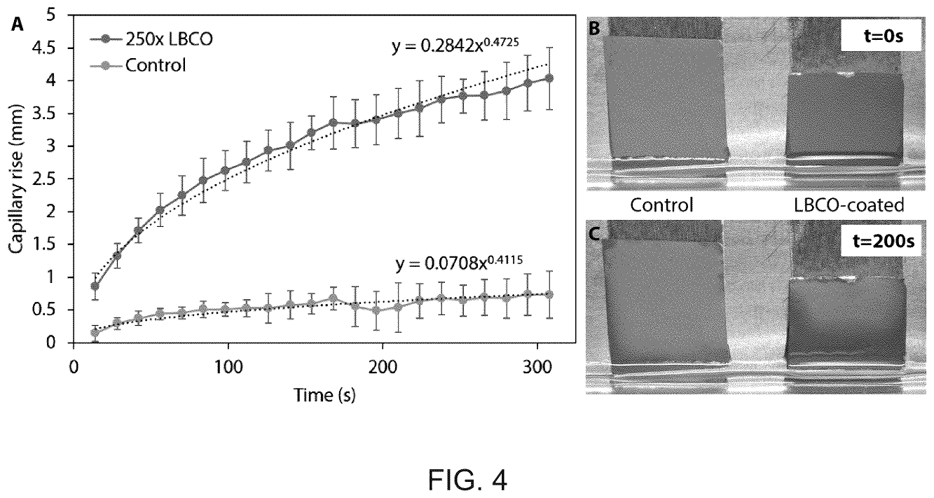

FIG. 4 depicts in panel a, the capillary rise of carbonate-based electrolyte through a calendered electrode measured over time with optical image analysis, and in panels b & c, images at beginning and 200 seconds after dipping the electrodes into the electrolyte. Eliminating SEI formation also reduces the need for slow, costly preconditioning to be performed following cell assembly. The LBCO coating also improves wetting of the electrolyte into the electrode (see FIG. 4), reducing time needed before preconditioning can commence.

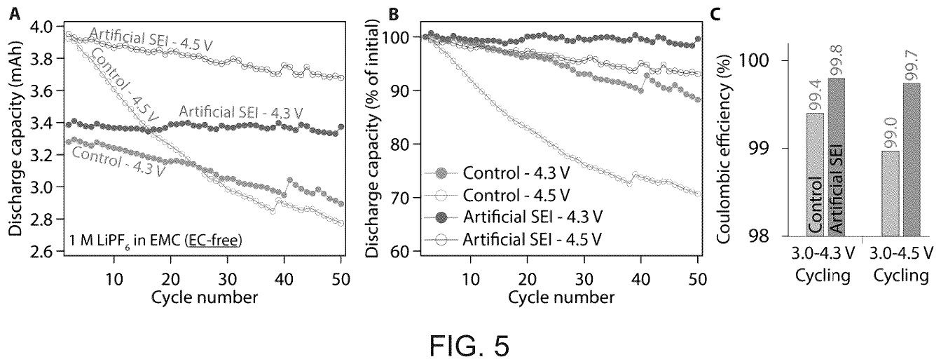

FIG. 5 depicts in panels a & b, the discharge capacity for 3.0 V lower cutoff voltage and 4.3 V & 4.5 V upper cutoff voltage with and without LBCO coating, and in panel c, the average Coulombic efficiency of the first 50 cycles at 1 C/1 C charge/discharge rates for 3.0 V lower cutoff voltage and 4.3 V & 4.5 V upper cutoff voltage. The LBCO coating enables the use of EC-free electrolytes with no additives, improving cycling stability at high cutoff voltages (4.3-4.5 V, see FIG. 5, panels a-c).

### Example 2

### A. Overview of Example 2

Another potential benefit of an artificial SEI like the LBCO is related to the precondition process. The present invention reduces the need for preconditioning. However, the preconditioning process also impacts interphase formation on the positive electrode in some cases. Therefore, the relaxed requirements for preconditioning related to the graphite negative electrode can open up new possibilities to improve performance/properties of the cathode electrolyte interphase (sometimes called CEI) formed on the positive electrode. For example, the optimal conditions for preconditioning the graphite-based anode may differ from the optimal conditions for the positive electrode (which may comprise, for example, LiNiₐMn_{b}Co_{c}O₂, wherein a+b+c=1 and a:b:c=5:3:2 (NMC 532)). In this case, we can improve performance by optimizing for the positive electrode without sacrificing the SEI formation process on the graphite-based anode, because we already have the artificial SEI in place on the anode.

### B. Experimental Methods and Results and Discussion

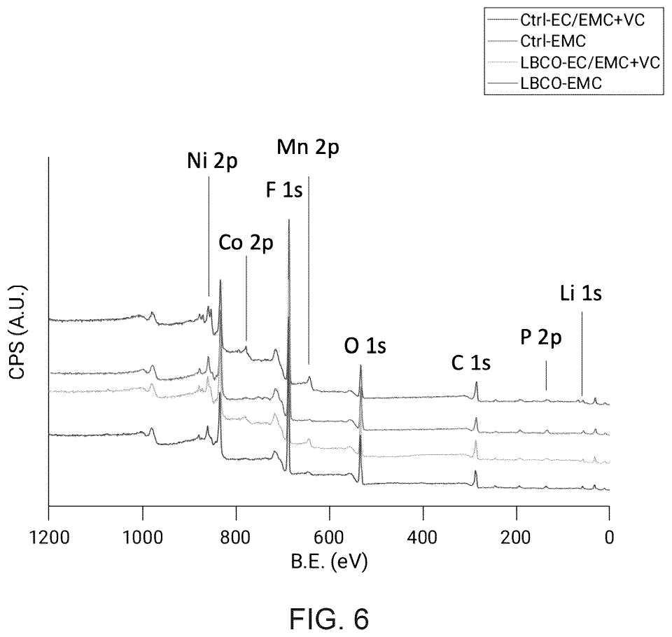

We collected X-ray photoelectron spectroscopy data that show one benefit of enabling ethylene carbonate-free electrolytes related to transition metal dissolution from NMC positive electrodes. The positive electrodes were prepared as in Example 1. As shown in FIG. 6, the electrodes with an ethyl methyl carbonate (EMC) only electrolyte (EC-free) have significantly reduced signal for the Ni 2p, Co 2p, and Mn 2p peaks. This is attributed to the elimination of the reaction mechanism involving dehydrogenation of ethylene carbonate (EC) at the NMC positive electrode surface. This enables EC-free electrolytes, as it can suppress the downsides related to EC's reactivity.

### Example 3

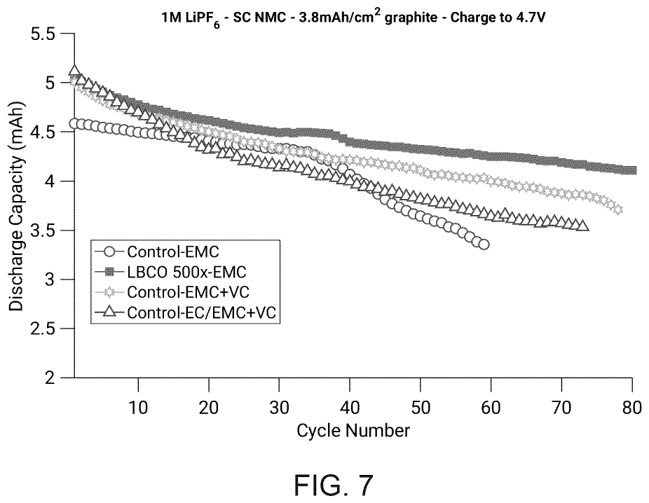

We explored another approach to enabling EC-free electrolytes. Shown in FIG. 7 are high voltage cycling data for the LBCO-coated graphite in the ethylene carbonate-free electrolyte as prepared in Example 1, and uncoated electrodes in ethylene carbonate-free electrolyte with and without 2% vinylene carbonate (VC) additive, and a conventional (ethylene carbonate-containing) electrolyte with the VC additive. The VC additive has been shown to aid in formation of the stable SEI in the absence of ethylene carbonate, therefore enabling more stable cycling in ethylene carbonate-free electrolytes. In the plot of FIG. 7, we show that the LBCO-coating outperforms all other cases, including the VC additive. Therefore, in addition to the other benefits of a coating approach compared to electrolyte modification (e.g., elimination of the precondition process), the LBCO coating provides a larger improvement to stability than probably the most commonly explored/reported approach (i.e., the use of a VC additive).

### Example 4

In this disclosure, we note that ethylene carbonate-free electrolytes can have higher ionic conductivity. Another important related aspect of the present disclosure is the temperature range of operation of the lithium ion battery. The freezing point of ethylene carbonate is much higher than the other carbonates, meaning that low temperature operation is restricted when ethylene carbonate is a component in the electrolyte. Table 1 below shows freezing points for reference.

TABLE 1

| | Freezing point | |
|---|---|---|
| ethylene carbonate (EC) | 36.4° | C. |
| ethyl methyl carbonate (EMC) | −14° | C. |
| propylene carbonate (PC) | −48.8° | C. |
| dimethyl carbonate (DMC) | 2-4° | C. |
| diethyl carbonate (DEC) | −43° | C. |
| vinylene carbonate (VC) | 22° | C. |
| fluoroethylene carbonate (FEC) | 18-23° | C. |

Thus, the high temperature operation of a lithium ion battery is also improved by the LBCO artificial SEI demonstrated in these Examples. At elevated temperature (e.g., 50° C.), continuous side reactions (related to SEI and CEI growth) are accelerated. The LBCO passivates the electrode and suppresses these side reactions, improving capacity retention.

### REFERENCES

1. Peled, et al., “Advanced Model for Solid Electrolyte Interphase Electrodes in Liquid and Polymer Electrolytes”, J. Electrochem. Soc. 144, L208-L210 (1997).
2. Peled, “The Electrochemical Behavior of Alkali and Alkaline Earth Metals in Nonaqueous Battery Systems—The Solid Electrolyte Interphase Model”, J. Electrochem. Soc. 126, 2047-2051 (1979).
3. Aurbach et al., “On the correlation between surface chemistry and performance of graphite negative electrodes for Li ion batteries”, Electrochim. Acta 45, 67-86 (1999).
4. Xu, “Electrolytes and interphases in Li-ion batteries and beyond”, Chem. Rev. 114, 11503-11618 (2014).
5. Kazyak et al., “Atomic layer deposition and first principles modeling of glassy Li₃BO₃—Li₂CO₃ electrolytes for solid-state Li metal batteries”, J. Mater. Chem. A 6, 19425-19437 (2018).
6. Kazyak et al., “Atomic Layer Deposition of the Solid Electrolyte Garnet Li₇La₃Zr₂O₁₂”, Chem. Mater. 29, 3785-3792 (2017).
7. Kazyak et al., “Atomic layer deposition and first principles modeling of glassy Li₃BO₃—Li₂CO₃ electrolytes for solid-state Li metal batteries”, J. Mater. Chem. A 6, 19425-19437 (2018).
8. Chen et al., “Efficient fast-charging of lithium-ion batteries enabled by laser-patterned three-dimensional graphite anode architectures”, J. Power Sources 471, 228475 (2020).
9. Kazyak et al., “Atomic layer deposition and first principles modeling of glassy Li₃BO₃—Li₂CO₃ electrolytes for solid-state Li metal batteries”, J. Mater. Chem. A 6, 19425-19437 (2018).

The citation of any document is not to be construed as an admission that it is prior art with respect to the present invention.

Thus, the present invention provides a coating process that deposits a protective coating on the surface of a lithium-ion battery electrode prior to cell assembly. This coating passivates the electrode surface, preventing side reactions during charging and increasing first cycle efficiency. Eliminating SEI formation also reduces the need for slow, costly preconditioning to be performed following lithium-ion battery cell assembly. The LBCO coating also improves wetting of the electrolyte into the electrode, reducing time needed before preconditioning can commence. The LBCO coating enables the use of EC-free electrolytes with no additives, improving cycling stability at high voltages for lithium-ion batteries.

In light of the principles and example embodiments described and illustrated herein, it will be recognized that the example embodiments can be modified in arrangement and detail without departing from such principles. Also, the foregoing discussion has focused on particular embodiments, but other configurations are also contemplated. In particular, even though expressions such as “in one embodiment”, “in another embodiment,” or the like are used herein, these phrases are meant to generally reference embodiment possibilities, and are not intended to limit the invention to particular embodiment configurations. As used herein, these terms may reference the same or different embodiments that are combinable into other embodiments. As a rule, any embodiment referenced herein is freely combinable with any one or more of the other embodiments referenced herein, and any number of features of different embodiments are combinable with one another, unless indicated otherwise.

Although the invention has been described in considerable detail with reference to certain embodiments, one skilled in the art will appreciate that the present invention can be practiced by other than the described embodiments, which have been presented for purposes of illustration and not of limitation. Therefore, the scope of the appended claims should not be limited to the description of the embodiments contained herein. Various features and advantages of the invention are set forth in the following claims.

1. A method for forming an electrochemical device, the method comprising:
(a) exposing anode material particles to a lithium-containing precursor followed by an oxygen-containing precursor to form a coating on the anode material particles;
(b) forming a slurry comprising the coated anode material particles;
(c) casting the slurry on a surface to form a layer;
(d) calendering the layer to form an anode of the electrochemical device;
(e) positioning a separator between the anode and a cathode to form a cell structure; and
(f) positioning the cell structure in a liquid electrolyte, wherein the electrolyte is essentially free of a solvent that forms a solid electrolyte interphase on the anode.

2. The method of claim 1 wherein step (a) further comprises exposing the anode material particles to a boron-containing precursor followed by the oxygen-containing precursor to form the coating on the anode material particles.

3. The method of claim 1 wherein:
the lithium-containing precursor comprises a lithium alkoxide.

4. The method of claim 2 wherein:
the boron-containing precursor comprises a boron alkoxide.

5. The method of claim 1 wherein:
the oxygen-containing precursor is selected from the group consisting of ozone, water, oxygen plasma, ammonium hydroxide, oxygen, and mixtures thereof.

6. The method of claim 2 wherein:
the lithium-containing precursor, the boron-containing precursor, and the oxygen-containing precursor are in a gaseous state.

7. The method of claim 1 wherein:
the anode material particles are graphite particles.

8. (canceled)

9. (canceled)

10. (canceled)

11. The method of claim 1 wherein:
the solvent that forms a solid electrolyte interphase on the anode is ethylene carbonate.

12. The method of claim 1 wherein:
the coating is a film having a thickness of 0.1 to 50 nanometers.

13. The method of claim 1 wherein:
step (a) occurs at a temperature between 50° C. and 280° C.

14. The method of claim 1 wherein:
the liquid electrolyte comprises a lithium compound in an organic solvent.

15. (canceled)

16. (canceled)

17. (canceled)

18. The method of claim 1 wherein:
the coating comprises Li₃BO₃—Li₂CO₃.

19. A method for forming an electrochemical device, the method comprising:
(a) forming a mixture comprising anode material particles;
(b) casting and/or calendering the mixture such that a porous structure is formed;
(c) exposing the porous structure to a lithium-containing precursor followed by an oxygen-containing precursor to form a coating on the porous structure thereby forming an anode;
(d) positioning a separator between the anode and a cathode to form a cell structure; and
(e) positioning the cell structure in a liquid electrolyte, wherein the electrolyte is essentially free of a solvent that forms a solid electrolyte interphase on the anode.

20. The method of claim 19 wherein step (c) further comprises exposing the porous structure to a boron-containing precursor followed by the oxygen-containing precursor to form the coating on the porous structure.

21. The method of claim 19 wherein:
the lithium-containing precursor comprises a lithium alkoxide.

22. The method of claim 20 wherein:
the boron-containing precursor comprises a boron alkoxide.

23. The method of claim 19 wherein:
the oxygen-containing precursor is selected from the group consisting of ozone, water, oxygen plasma, ammonium hydroxide, oxygen, and mixtures thereof.

24. The method of claim 20 wherein:
the lithium-containing precursor, the boron-containing precursor, and the oxygen-containing precursor are in a gaseous state.

25. The method of claim 19 wherein:
the anode material particles are graphite particles.

26. (canceled)

27. (canceled)

28. (canceled)

29. The method of claim 19 wherein:
the solvent that forms a solid electrolyte interphase on the anode is ethylene carbonate.

30. The method of claim 19 wherein:
the coating is a film having a thickness of 0.1 to 50 nanometers.

31. (canceled)

32. (canceled)

33. (canceled)

34. (canceled)

35. (canceled)

36. The method of claim 19 wherein:
the coating comprises Li₃BO₃—Li₂CO₃.

37. A method for forming an electrochemical device, the method comprising:
(a) exposing cathode material particles to a lithium-containing precursor followed by an oxygen-containing precursor to form a coating on the cathode material particles;
(b) forming a slurry comprising the coated cathode material particles;
(c) casting the slurry on a surface to form a layer;
(d) calendering the layer to form a cathode of the electrochemical device;
(e) positioning a separator between the cathode and an anode to form a cell structure; and
(f) positioning the cell structure in a liquid electrolyte, wherein the electrolyte is essentially free of a solvent that forms a solid electrolyte interphase on the cathode.

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. A method for forming an electrochemical device, the method comprising:
(a) forming a mixture comprising cathode material particles;
(b) casting and/or calendering the mixture such that a porous structure is formed;
(c) exposing the porous structure to a lithium-containing precursor followed by an oxygen-containing precursor to form a coating on the porous structure thereby forming a cathode;
(d) positioning a separator between the cathode and an anode to form a cell structure; and
(e) positioning the cell structure in a liquid electrolyte, wherein the electrolyte is essentially free of a solvent that forms a solid electrolyte interphase on the cathode.

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)
